(19) United States
(12) Patent Application Publication
(10) Pub. No.: US 2011/0196916 A1
(43) Pub. Date: Aug. 11, 2011

(54) CLIENT TERMINAL, SERVER, CLOUD COMPUTING SYSTEM, AND CLOUD COMPUTING METHOD

(75) Inventor: Yeong-Kyeong Seong, Suwon-si (KR)

(73) Assignee: Samsung Electronics Co., Ltd., Suwon-si (KR)

(21) Appl. No.: 12/959,743

(22) Filed: Dec. 3, 2010

(30) Foreign Application Priority Data
Feb. 8, 2010 (KR) 10-2010-0011638

(51) Int. Cl. G06F 15/16; G06K 9/00

(52) U.S. Cl. 709/203; 382/107

(57) ABSTRACT

An apparatus and method for improving the transmission quality of data in a cloud computing environment are provided. The cloud computing system includes a terminal and a server for executing an application requested by the terminal. The server, according to a result of the application execution, specifies a region of interest in a data stream which is received from the terminal. The terminal, based on the specified region of interest, adjusts settings such that the region of interest in the data stream has a transmission quality that is different from a transmission quality of remaining regions of the data stream to be transmitted to the server.

### CROSS-REFERENCE TO RELATED APPLICATION

This application claims the benefit under 35 U.S.C. §119(a) of Korean Patent Application No. 10-2010-0011638, filed on Feb. 8, 2010, the entire disclosure of which is incorporated herein by reference for all purposes.

### BACKGROUND

1. Field

The following description relates to a data transmission technology in a cloud computing environment, and more particularly, to a data transmission technology adjusts the quality of a data stream based on the region of interest to optimize efficiency and minimize the cost of data processing between a terminal and a server.

2. Description of the Related Art

A cloud computing service provides computing resources that are requested by a user through an internet service, regardless of time and location.

In such a cloud computing service, when a client requests the execution of a predetermined application, a server executes the predetermined application and transmits the result of execution to the client. Accordingly, in the cloud computing service, the client is regarded as an input/output device.

The computing resources that are provided by the cloud computing service include software resources such as applications and development platforms, and hardware resources such as a central processing unit (CPU), a memory, and storage.

When a cloud computing service is used, a user of the terminal receives the result of execution of a predetermined application by use of computing resources of a remote server without the terminal having to perform/execute the particular operation.

In addition, data of a user is stored in a server having a high reliability, thereby ensuring the security of the data, and providing a personal computing environment even to users who do not have a personal terminal of their own, but instead access the server through a public computer connected to the internet.

### SUMMARY

In one general aspect, there is provided a cloud computing system for executing a requested application, the cloud computing system comprising a server that receives a request for executing an application, and specifies a region of interest in a data stream which is received from the terminal, based on a result of executing an application, and a terminal that adjusts settings, based on the specified region of interest, such that the region of interest in the data stream has a transmission quality that is different from a transmission quality of the remaining regions of the data stream.

The data stream may include an image data stream.

The server may specify the region of interest in a first frame of the image data stream.

The server may specify a region of the first frame that has an object of interest to the application as the region of interest.

The terminal may adjust settings such that a region of a second frame of the image data stream corresponding to the region of interest has a transmission quality that is different from a transmission quality of the remaining regions of the second frame.

The terminal may adjust settings such that the remaining regions have a compression ratio that is higher than a compression ratio of the region of interest.

In another aspect, there is provided a server apparatus comprising a data processing unit configured to execute an application requested by a client terminal and process a data stream received from the client terminal, an interested region specifying unit configured to detect a region of interest in the data stream based on the execution of the application, and an interested region providing unit configured to provide the client terminal with information about the region of interest.

The data stream may include an image data stream.

The interested region specifying unit may specify the region of interest in a first frame of the image data stream.

The interested region specifying unit may specify a region of the first frame that has an object of interest of the application as the region of interest.

The interested region specifying unit may include a detection unit configured to detect at least one representative region of interest including the object of interest of the application based on the execution of the application, and a selection unit configured to estimate a motion of the object of interest and select one of the representative regions of interest as the region of interest based on the estimated motion.

In another aspect, there is provided a client terminal apparatus comprising an interested region receiving unit configured to receive, from a server, information about a region of interest in a data stream that is to be transmitted to the server, and a quality setting unit configured to adjust settings such that the region of interest in the data stream has a transmission quality that is different from a transmission quality of remaining regions of the data stream.

The data stream may include an image data stream.

The quality setting unit may adjust settings such that the remaining regions have a compression ratio that is higher than a compression ratio of the region of interest.

In another aspect, there is provided a cloud computing method comprising at a server, specifying a region of interest in a data stream received from the terminal, based on the result of executing an application requested by the terminal, and at the terminal, based on the specified region of interest, adjusting settings such that the region of interest in the data streams has a transmission quality that is different from a transmission quality of remaining regions of the data stream.

The data stream may include an image data stream.

The specifying of the region of interest may include specifying the region of interest in a first frame of the image data stream.

The specifying of the region of interest may include specifying a region of the first frame that has an object of interest to the application as the region of interest.

The adjusting of settings of transmission quality may be performed such that a region of a second frame of the image data stream corresponding to the region of interest has a transmission quality that is different from a transmission quality of the remaining regions of the second frame.

The adjusting of settings of transmission quality may be performed such that the remaining regions have a compression ratio that is higher than a compression ratio of the region of interest.

Other features and aspects may be apparent from the following description, the drawings, and the claims.

### BRIEF DESCRIPTION OF THE DRAWINGS

FIG. 1 is a diagram illustrating an example of a cloud computing system.

FIG. 2 is a diagram illustrating an example of a server apparatus.

FIG. 3 is a diagram illustrating an example of an interested region specifying unit.

FIG. 4 is a diagram illustrating an example of a client terminal apparatus.

FIG. 5 is a diagram illustrating an example of an image data stream.

FIG. 6 is a diagram illustrating an example of a cloud computing method.

Throughout the drawings and the description, unless otherwise described, the same drawing reference numerals should be understood to refer to the same elements, features, and structures. The relative size and depiction of these elements may be exaggerated for clarity, illustration, and convenience.

### DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein may be suggested to those of ordinary skill in the art. Also, descriptions of well-known functions and structures may be omitted for increased clarity and conciseness.

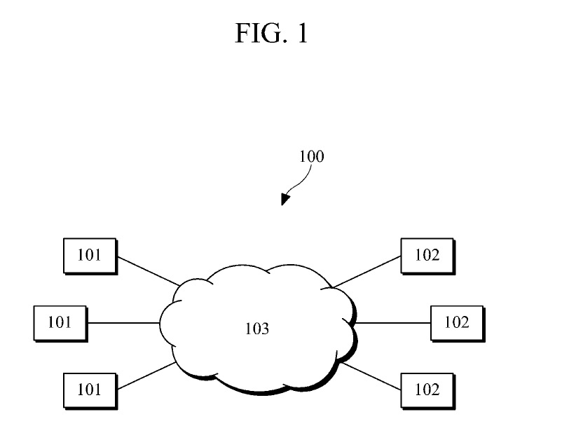

FIG. 1 illustrates an example of a cloud computing system.

Referring to FIG. 1, cloud computing system 100 includes a plurality of terminals 101 and a plurality of servers 102. Each terminal 101 is connected to one or more of the plurality of servers 102 through a network 103. A terminal 101 issues a request for application execution to a server 102 and transmits data related to the application. The server 102 processes the received data in response to the request for application execution of the terminal 101 and provides a result of the execution to the terminal 101.

A terminal 101 may transmit an image data stream to a server 102, and request the server 102 to execute a predetermined application to process the transmitted image data stream.

A terminal 101 may transmit a plurality of data frames while transferring image data to the server 102 in a stream. The server 102 may specify a region of interest in a first frame of the image data stream that is received from the terminal 101, based on the type of the application requested by the terminal 101 and the result of the execution of the application. For example, if a terminal 101 requests the execution of an application that is used to recognize the face of a human, the server 102 may attempt to detect a face from one of the frames in the received image data and specify the face region as a region of interest.

The region of interest may be a region of a frame included in an image data stream. The region corresponding to the region of interest may be a region that has an object of interest of an application. The object of interest of an application may vary based on the type of application. For example, if the application is an object recognition program, the object of interest may be any object included in an image. Examples of an object that may be included in an image include, but are not limited to, a weapon, an instrument, an automobile, a ball, and the like. If the application is a face-image recognition program, the object of interest may be a face included in an image.

Based on the region of interest, the terminal 101 may adjust settings such that a region of interest in a second frame of the image data stream, which is to be transmitted to the server 102, may have a transmission quality that is different from the transmission quality of the rest of the second frame. For example, if the sever 102 detects a face in a first frame of an image data stream and specifies the face region as a region of interest, the terminal 101 may reduce the compression ratio of a face region of a second frame of the image data stream that corresponds to the region of interest. In addition, the server 102 may increase the compression ratio of the remaining regions of the second frame.

Accordingly, when data is transmitted, the cloud computing system 100 may improve the quality of a region of image data that is more frequently used by an application and degrade the quality of the remaining regions of the image, thereby reducing the cost for data transmission between the terminal 101 and the server 102.

As an example, the terminal 101 may be a personal computer, a smart phone, a mobile phone, a personal digital assistant (PDA) that is connectable to the network 103, and the like. The server 102 may be, for example, a cloud server that processes various tasks requested by the terminal 101 through application virtualization.

As another example, the terminal 101 and the server 102 may be applied to a general client environment instead of the cloud environment.

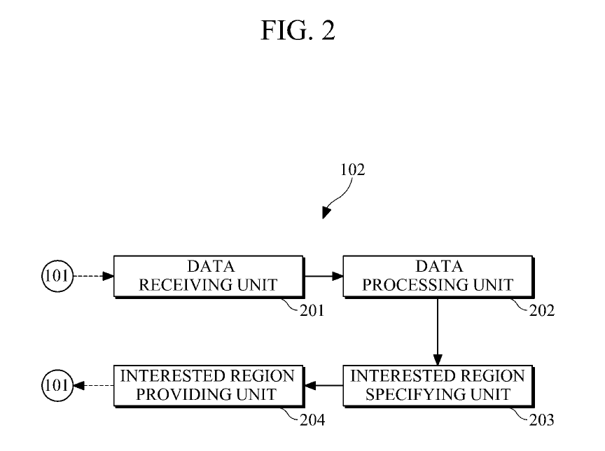

FIG. 2 illustrates an example of a server apparatus.

Referring to FIG. 2, the server 102 includes a data receiving unit 201, a data processing unit 202, an interested region specifying unit 203, and an interested region providing unit 204.

The data receiving unit 201 receives a data stream form the terminal 101. For example, the data receiving unit 201 may receive a plurality of frames of image data and temporally store the received frames.

The data processing unit 202 receives the data stream from the data receiving unit 201 and processes the received data stream based on an application requested by the terminal 101. For example, if the application requested by the terminal 101 is a face-image recognition program, the data processing unit 202 may attempt to detect a face region from a predetermined image frame of the image data stream that is received from the data receiving unit 201 by operating the face-image processing program.

The interest region specifying unit 203 specifies a region of interest in the received data stream based on the result of application execution. For example, if the data processing unit 202 detects a face region, the interest region specifying unit 203 may specify a region corresponding to the face region as a region of interest.

In this example, the detected face region does not need to be identical to the specified region of interest. For example, if the terminal 101 takes a picture of a person in motion and transmits a moving picture data stream to the server 102, a “face” may change position from among the individual image frames. Because the “face” may change positions in the frame from one image frame to another image frame, the interest region specifying unit 203 may specify a region around the detected “face” as the region of interest. Alternatively, the interest region specifying unit 203 may estimate the position of the face in a following frame and specify a region of interest based on the estimated position of the face.

The interest region providing unit 204 provides information about the specified region of interest to the terminal 101. For example, the interest region providing unit 204 may set a predetermined window related to a region of interest and provide the terminal 101 with information about various image information, for example, coordinates of the center of the window, information about the window size, and the like.

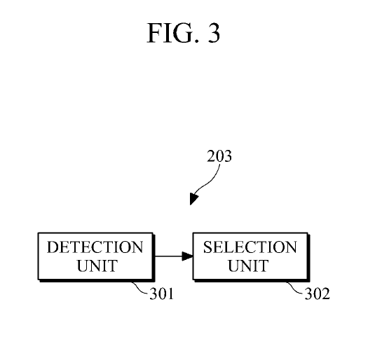

FIG. 3 illustrates an example of an interested region specifying unit.

Referring to FIG. 3, the interest region specifying unit 203 includes a detection unit 301 and a selection unit 302.

According to the result of the execution of an application, the detection unit 301 detects at least one representative region of interest, which includes a region that has an object of interest to the application. For example, if a face is detected based on the result of execution of a face-image recognition program, the detection unit 301 may set one or more regions of interest around the detected face.

The selection unit 302 may estimate a motion of the object of interest, and select one of the representative regions of interest as the region of interest based on the estimated motion. For example, the selection unit 302 may estimate the position of a face in a second frame followed by a first frame based on the position of a face in the first frame and the estimated motion of the face in the first frame. Subsequently, the selection unit 302 may select one of a plurality of representative regions of interest as the region of interest based on the estimated position of the face in the second frame.

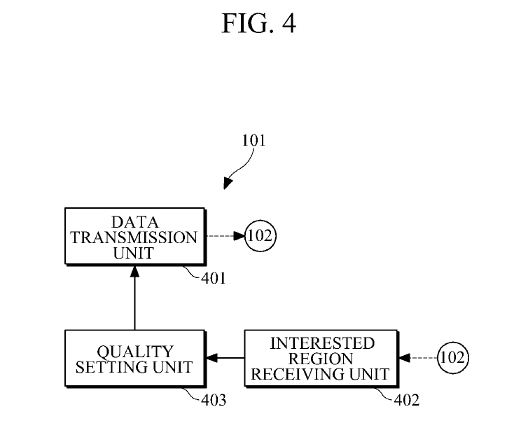

FIG. 4 illustrates an example of a client terminal apparatus.

Referring to FIG. 4, the terminal 101 includes a data transmission unit 401, an interest region receiving unit 402, and a quality setting unit 403.

The data transmission unit 401 transmits a data stream to the server 102. For example, the data transmission unit 401 may transmit a plurality of frames of image data in a stream.

The interest region receiving unit 402 receives information about a region of interest from the server 102. For example, the interest region receiving unit 402 may receive coordinates of the center of a predetermined window related to a region of interest, information about the window size, and the like. The region of interest may be a region that has an object of interest to an application. The object is included in frames of an image data stream which has been transmitted or is to be transmitted to the server 102. For example, if an application running in the sever 102 is a face-image recognition program, the object of interest of the application may be a face existing in an image and the region of interest of the application may be a region of an image corresponding to the face.

The quality setting unit 403 determines the transmission quality of a data stream, which is to be transmitted to the server 102, based on the information about the region of interest received from the server 102. For example, the transmission quality may be determined based on the compression ratio. For example, if the region of interest corresponds to a face region included in an image, the quality setting unit 403 may reduce the compression ratio of the face region in an image frame to be transmitted to the server 102 and increase the compression ratio of the remainder of the image frame.

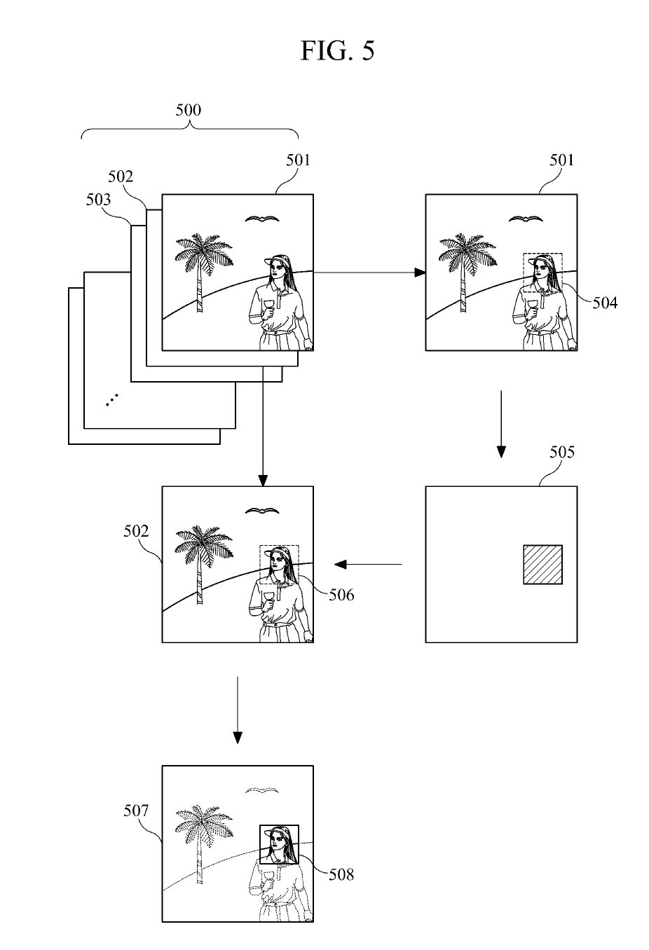

FIG. 5 illustrates an example of an image data stream.

Referring to FIG. 5, image data stream 500 includes a plurality of image frames 501, 502, and 503.

The terminal 101 transmits image frames 501, 502, and 503, respectively, to the server 102 in a stream. For example, the terminal 101 may transmit the first image frame 501 to the server 102 and may request the server 102 to perform face recognition through an application.

The server 102 may detect a face region in the first image frame 501 received from the terminal 101. The server 102 may specify a region of interest based on the detected face region. In addition, the server 102 may generate information 505 about the specified region of interest, and transmit the information to the terminal 101.

The terminal 101 may receive the information 505 about the region of interest, and specify a region of interest 506 in the second image frame 502 followed by the first image frame 501 based on the information 505. The terminal 101 may adjust settings such that the specified region of interest 506 in the second frame 502 has a transmission quality that is different from that of the remaining region of the second frame. For example, as shown with reference numeral 507, the terminal 101 may reduce data compression corresponding to a face region 508 in the frame 507 and increase data compression corresponding to the remaining region of the frame such that the data quality of the face region 508 is improved and the overall amount of data transfer is reduced.

If the terminal 101 provides the server 102 with the second image frame 507 having a changed transmission quality, the server 102 may specify a region of interest in the second image frame 507, and the terminal 101 may adjust the transmission quality of a third image frame 503 based on the specified region of interest 507.

As described above, the region of interest 504 may be determined based on the position of a face detected in the first image frame 501 and an estimated position of a face in the second image frame 502. For example, the region of interest 504 may be specified by moving or expanding the detected position of the face based on the tendency of an object or person moving in the frames.

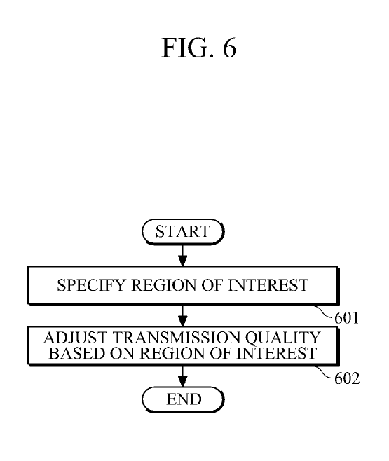

FIG. 6 illustrates an example of a cloud computing method.

Referring to FIG. 6, a cloud computing method includes a process 601 in which the server 102 specifies a region of interest in a data stream that is received from the terminal 101, based on the execution of an application that is requested by the terminal 101. For example, if the terminal 101 sends the server 102 a plurality of frames about an image data in a stream and issues a request for execution of a face-image recognition program to the server 102, the server 102 may detect a face in a received first frame and specify, based on the detected face, a region of interest in a second frame to be received.

The cloud computing method includes a process in which the terminal 101 adjusts settings such that a region corresponding to the specified region of interest in a data stream to be transmitted to the server 102, has a transmission quality that is different than the transmission quality of the remainder of the data stream. For example, the terminal 101 may reduce the compression ratio corresponding to the region of interest in data and increase the compression ratio corresponding to the remaining regions of the image frame, thereby improving the quality of data.

As described above, the transmission quality of a data stream may be adjusted based on the region of interest such that the cost of data processing between the terminal 101 and the server 102 is minimized and the efficiency of data processing of the server 102 is optimized.

The methods described above may be recorded, stored, or fixed in one or more computer-readable storage media that includes program instructions to be implemented by a computer to cause a processor to execute or perform the program instructions. The media may also include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The described hardware devices may be configured to act as one or more software modules in order to perform the operations and methods described above, or vice versa. In addition, a computer-readable storage medium may be distributed among computer systems connected through a network and computer-readable codes or program instructions may be stored and executed in a decentralized manner.

As a non-exhaustive illustration only, the terminal device described herein may refer to mobile devices such as a cellular phone, a personal digital assistant (PDA), a digital camera, a portable game console, an MP3 player, a portable/personal multimedia player (PMP), a handheld e-book, a portable lab-top personal computer (PC), a global positioning system (GPS) navigation, and devices such as a desktop PC, a high definition television (HDTV), an optical disc player, a setup box, and the like, capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer.

It should be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A cloud computing system for executing a requested application, the cloud computing system comprising:
a server that receives a request for executing an application, and specifies a region of interest in a data stream which is received from the terminal, based on a result of executing an application; and
a terminal that adjusts settings, based on the specified region of interest, such that the region of interest in the data stream has a transmission quality that is different from a transmission quality of the remaining regions of the data stream.

2. The cloud computing system of claim 1, wherein the data stream includes an image data stream.

3. The cloud computing system of claim 2, wherein the server specifies the region of interest in a first frame of the image data stream.

4. The cloud computing system of claim 3, wherein the server specifies a region of the first frame that has an object of interest to the application as the region of interest.

5. The cloud computing system of claim 3, wherein the terminal adjusts settings such that a region of a second frame of the image data stream corresponding to the region of interest has a transmission quality that is different from a transmission quality of the remaining regions of the second frame.

6. The cloud computing system of claim 1, wherein the terminal adjusts settings such that the remaining regions have a compression ratio that is higher than a compression ratio of the region of interest.

7. A server apparatus comprising:
a data processing unit configured to execute an application requested by a client terminal and process a data stream received from the client terminal;
an interested region specifying unit configured to detect a region of interest in the data stream based on the execution of the application; and
an interested region providing unit configured to provide the client terminal with information about the region of interest.

8. The server apparatus of claim 7, wherein the data stream includes an image data stream.

9. The server apparatus of claim 8, wherein the interested region specifying unit specifies the region of interest in a first frame of the image data stream.

10. The server apparatus of claim 9, wherein the interested region specifying unit specifies a region of the first frame that has an object of interest of the application as the region of interest.

11. The server apparatus of claim 8, wherein the interested region specifying unit includes:
a detection unit configured to detect at least one representative region of interest including the object of interest of the application based on the execution of the application; and
a selection unit configured to estimate a motion of the object of interest and select one of the representative regions of interest as the region of interest based on the estimated motion.

12. A client terminal apparatus comprising:
an interested region receiving unit configured to receive, from a server, information about a region of interest in a data stream that is to be transmitted to the server; and
a quality setting unit configured to adjust settings such that the region of interest in the data stream has a transmission quality that is different from a transmission quality of remaining regions of the data stream.

13. The client terminal apparatus of claim 12, wherein the data stream includes an image data stream.

14. The client terminal apparatus of claim 12, wherein the quality setting unit adjusts settings such that the remaining regions have a compression ratio that is higher than a compression ratio of the region of interest.

15. A cloud computing method comprising:
at a server, specifying a region of interest in a data stream received from the terminal, based on the result of executing an application requested by the terminal; and
at the terminal, based on the specified region of interest, adjusting settings such that the region of interest in the data streams has a transmission quality that is different from a transmission quality of remaining regions of the data stream.

16. The cloud computing method of claim 15, wherein the data stream includes an image data stream.

17. The cloud computing method of claim 16, wherein the specifying of the region of interest includes specifying the region of interest in a first frame of the image data stream.

18. The cloud computing method of claim 17, wherein the specifying of the region of interest includes specifying a region of the first frame that has an object of interest to the application as the region of interest.

19. The cloud computing method of claim 17, wherein the adjusting of settings of transmission quality is performed such that a region of a second frame of the image data stream corresponding to the region of interest has a transmission quality that is different from a transmission quality of the remaining regions of the second frame.

20. The cloud computing method of claim 15, wherein the adjusting of settings of transmission quality is performed such that the remaining regions have a compression ratio that is higher than a compression ratio of the region of interest.
